(19) United States
(12) Patent Application Publication
(10) Pub. No.: US 2015/0086312 A1
(43) Pub. Date: Mar. 26, 2015

(54) Storage Assembly

(71) Applicant: David Ohnesorge, Columbia, MO (US)

(72) Inventor: David Ohnesorge, Columbia, MO (US)

(21) Appl. No.: 14/033,311

(22) Filed: Sep. 20, 2013

(51) Int. Cl. B60R 11/06

(52) U.S. Cl. CPC B60R 11/06; B60R 2011/004
USPC 414/462

(57) ABSTRACT

An apparatus comprises a mounting bracket engaged with an inside of a vehicle cargo area. An axle having a first end portion and a second end portion is oriented longitudinally inside the vehicle cargo area to engage with the mounting bracket. A first radius arm has a vehicle end portion and a container end portion that is engaged with the first end portion of the axle and to a first pivot assembly on a container, respectively. A second radius arm has a vehicle end portion and a container end portion that is engaged with the second end portion of the axle and to a second pivot assembly on the container, respectively. The first and second radius arms are configured to be operable to deploy the container from the inside of the vehicle cargo area to a sidewall of the vehicle cargo area in a generally arcing motion.

### CROSS-REFERENCE TO RELATED APPLICATIONS

Not applicable

### RELATED CO-PENDING U.S. PATENT APPLICATIONS

Not applicable

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to storage assemblies. More particularly, the invention relates to storage assemblies that rotate arms joined to a container in vehicle storage through a raising and lowering arc movement.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a toolbox is a box to organize, carry, and protect tools. The tools could be used for trade or hobby, and their contents vary with the craft of the owner.

Typically, tool carts are commonly used in the transportation industry for maintenance and repair of vehicles on location. Used as portable work stations, some of the larger types are self-powered and propelled, for example, pit carts in automobile racing.

Often, a pickup truck is a light motor vehicle with an open-top, rear cargo area, like a bed. Full-size pickup trucks are generally available with several different types of beds attached. The provided lengths typically specify the distance between the inside of the front end of the bed and the closed tailgate. Each manufacturer may utilize a differently sized and dimensioned bed.

In many instances, accessing the tools in the tool box from the bed may be difficult, especially if the toolbox is deep. Space and carrying capacity in the bed may also be minimized due to the space taken up by the toolbox.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary storage assembly in a stowed position in an exemplary vehicle storage portion, in accordance with an embodiment of the present invention;

FIG. 2 illustrates a rear view of an exemplary storage assembly in a stowed position in an exemplary vehicle storage portion, in accordance with an embodiment of the present invention;

FIG. 3 illustrates a detailed perspective view of an exemplary storage assembly in a raised position in an exemplary vehicle storage portion, in accordance with an embodiment of the present invention;

FIG. 4 illustrates a rear view of an exemplary storage assembly in a raised position in an exemplary vehicle storage portion, in accordance with an embodiment of the present invention;

FIG. 5 illustrates a detailed perspective view of an exemplary storage assembly in a raised position in an exemplary vehicle storage portion with an exemplary front door opened, in accordance with an embodiment of the present invention;

FIG. 6 illustrates a rear view of an exemplary storage assembly in a raised position in an exemplary vehicle storage portion with an exemplary front door opened, in accordance with an embodiment of the present invention;

FIG. 7 illustrates a detailed perspective view of an exemplary axle joining an exemplary pair of arms, in accordance with an embodiment of the present invention;

FIG. 8 illustrates a detailed perspective view of an exemplary mounting bracket and an exemplary anchor sprocket attached, in accordance with an embodiment of the present invention;

FIG. 9 illustrates a detailed perspective view of an exemplary anchor sprocket, in accordance with an embodiment of the present invention;

FIG. 10 illustrates a detailed perspective view of an exemplary container with an exemplary container pivot assembly attached, in accordance with an embodiment of the present invention;

FIG. 11 illustrates a detailed perspective view of an exemplary arm with a stabilization portion attached, in accordance with an embodiment of the present invention;

FIG. 12 illustrates a detailed perspective view of an exemplary container with an exemplary motor and an exemplary gearbox portion, in accordance with an embodiment of the present invention;

FIG. 13 illustrates a rear view of an exemplary container in a stowed position in a vehicle storage portion, in accordance with an embodiment of the present invention; and

FIG. 14 illustrates a rear view of an exemplary container in a raised position on a top edge of at least one sidewall, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

The present invention will now be described in detail with reference to embodiments thereof as illustrated in the accompanying drawings.

There are various types of storage assemblies that may be provided by preferred embodiments of the present invention. In one embodiment of the present invention, the storage assembly may pivotally raise and lower a pair of arms that are joined to a container through an arc movement. The arc movement may be angled to maintain the container in a stable, level orientation with a vehicle storage portion. The arc movement may result in the container traveling in a slightly downward path during the raising or deploying motion. In some embodiments, the container may raise and lower through the arc movement between two positions—within a perimeter area of the vehicle storage portion, and on at least one sidewall of the vehicle storage portion. In one embodiment, the addition of a hinge point in the pair of arms or the addition of another linkage point can be used to result in a modified arc motion.

In one embodiment, the container may rest in the perimeter area of the vehicle storage portion, such as the bed of a pickup truck, when in a stowed position. In the other position, the pair of arms may also pivotally raise the container through the arc movement to the raised position, finally resting the container on the at least one sidewall of the peripheral storage area. A stabilization portion maintains the container in a level, stable orientation during movement between each position, and while the vehicle is operating. In some embodiments, the container locks onto the at least one sidewall through friction and mechanical connections of the at least one arm. The lock mechanism may be actuated when the at least one arm presses the container down on a top edge of the at least one sidewall, thereby removing any slack in the connection between the container and each arm. Frictional forces and gravity may then enhance the locked, raised position of the container. The locking mechanism may allow the vehicle to be driven while the container is in the raised position. Those skilled in the art, in light of the present teachings, will recognize that when the container is in the raised position, additional space is created in the vehicle storage portion. Further, even in the stowed position, the container may conserve additional space in the vehicle storage portion by positioning along the peripheral area, below the level of the top edge of the sidewall. In one embodiment, the vehicle is a truck with a bed area for storage. In other embodiments, the vehicle may be an ATV, a golf cart, and any other vehicle similar in usage to pickup trucks.

In one embodiment of the present invention, the storage assembly may include a pair of arms disposed to join with a container at a pair of mounting ends. The pair of arms may include an arm vehicle end for joining with the vehicle, and an arm container end for joining with the container. The container may include, without limitation, a tool box. The container may include a top door for regulating access to at least one item. The top door may position on an upper surface of the container, and be accessible when the container is in the raised position or the stowed position. A front door may position on a side surface of the container, and be accessible only when the container is in the raised position, due to restricted access by the vehicle storage sidewalls in the stowed position. The container may be made of, without limitation, steel, stainless steel, aluminum, fiberglass, plastic, fiber reinforced plastic, wood, or any combination thereof.

In one embodiment of the present invention, an axle may be disposed to position between each arm. The axle may be essentially solidly attached to the pair of arms. The rotation of the axle causes the rotation of the pair of arms. The axle rotates to allow for the arc movement of the storage assembly. A motor powers the assembly. The motor may transmit rotational power to the axle through a gear portion. A control portion may position on the container, controlling the movement of the assembly.

In one embodiment of the present invention, the assembly may remain level in relation to the vehicle storage portion while moving between positions, and while the vehicle is operating. A stabilization portion may provide the assembly the stability to maintain this even keel. In some embodiments, a pair of mounting brackets may join with an inner surface of the vehicle storage sidewalls. Each mounting bracket may join with each arm vehicle end through an anchor sprocket. The anchor sprocket may be essentially solidly attached to the mounting bracket, and may contain a bearing surface that allows it to be operable to serve as a rear bearing for pivoting the assembly. The anchor sprocket may not engage or contact the arm

In one embodiment, a container pivot assembly may join each mounting end of the container, providing a pivot axle point to operatively join the container to the arm container end. From the arm container end, a pivot sprocket may join with the container by overlaying on the container pivot assembly. The pivot sprocket may include a rotary sprocket configuration that, allows it to maintain the container at a level position. The pivot sprocket rotates independently of the arm arc movement, by not being on contact with the arm. The pivot sprocket is essentially solidly attached to the container when it overlays with the container pivot assembly

In one embodiment of the present invention, a chain portion may form a loop around the pivot sprocket and the anchor sprocket. The chain portion may follow a path around an outer perimeter of each arm by rolling around a chain guide. The chain portion may also engage a tensioning guide configured to increase and decrease tension on the chain portion through slight adjustments in positioning. In operation, the chain portion forms a bridge between the anchor sprocket and the pivot sprocket, allowing the anchor sprocket to maintain a relative position with the pivot sprocket. Since the pivot sprocket overlays and moves in conjunction with the container pivot assembly, the container maintains the same relative orientation to the vehicle storage portion at any point along the arc movement. The chain portion between the sprockets ensures that the pivot sprocket maintains the same torsional position to the anchor sprocket throughout the arc movement.

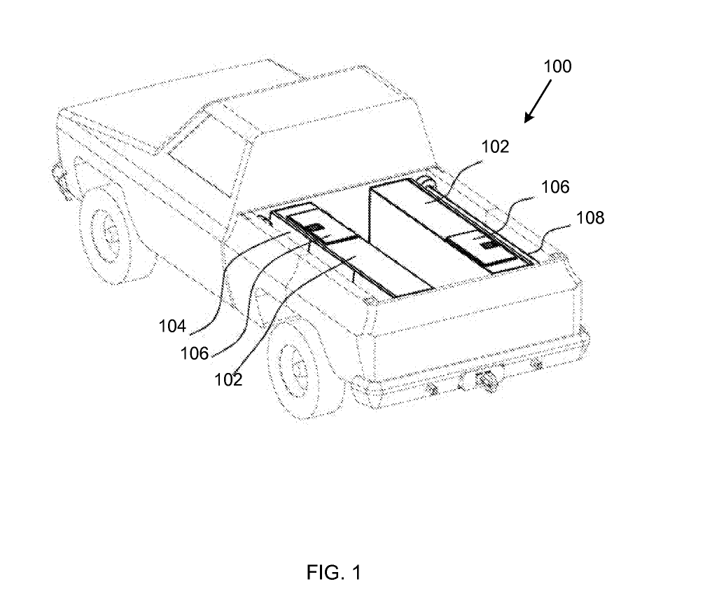

FIG. 1 illustrates a detailed perspective view of an exemplary storage assembly in a stowed position in an exemplary vehicle storage portion, in accordance with an embodiment of the present invention. In the present embodiment, a storage assembly 100 may pivotally raise and lower a pair of arms that are joined to a container 102 through an arc movement. The arc movement may be angled to maintain the container in a stable, level orientation with a vehicle storage portion. The arc movement may result in the container traveling in a slightly downward path during the raising or deploying motion. By way of example, and not limitation, in some practical applications at the beginning of the raising motion (e.g., traveling only in a vertical (up) direction), as the travel approaches the top of the arc and travels past the top of the arc then the toolbox will be traveling in this downward path. In some embodiments, the container may raise and lower though the arc movement between two positions—within a perimeter area of the vehicle storage portion, and onto at least one sidewall of the vehicle storage portion.

In one embodiment, the container may rest in the perimeter area of the vehicle storage portion, such as the bed of a pickup truck, when in a stowed position. In the other position, the pair of arms may also pivotally raise the container through the arc movement to the raised position, finally resting the container on the at least one sidewall of the peripheral storage area. In some embodiments, a passenger side of a vehicle and an operator side of the vehicle may each have a storage assembly.

In one embodiment, a stabilization mechanism may help maintain the container in a level, stable orientation during movement between each position, and while the vehicle is operating. In some embodiments, the container locks onto the at least one sidewall through friction and/or mechanical connections of the at least one arm. The container may also, without limitation, lock on with magnets, a pin and socket arrangement, and a clamping system actuated manually or automatically. The lock mechanism may be actuated when the at least one arm presses the container down on a top edge of the at least one sidewall, thereby removing any slack in the connection between the container and each arm. Frictional forces and gravity may then enhance the locked, raised position of the container. The locking mechanism may allow the vehicle to be driven while the container is in the raise position. Those skilled in the art, in light of the present teachings, will recognize that when the container is in the raised position, additional space is created in the vehicle storage portion. Further, even in the stowed position, the container may conserve additional space in the vehicle storage portion by positioning along the peripheral area, below the level of the top edge of the sidewall. In some embodiments, the container may include, without limitation, a tool box. The container may include a top door 106 for regulating access to at least one item. The top door may position on an upper surface of the container, and be accessible when the container is in the raised position or the stowed position. A front door 104 may position on a side surface of the container, and be accessible only when the container is in the raised position, due to restricted access by the vehicle storage sidewalls in the stowed position. In one embodiment, an axle 108 may be disposed to position between a pair of arms that carry the container. The axle rotates to allow for the arc movement of the storage assembly, which lifts and lowers the container.

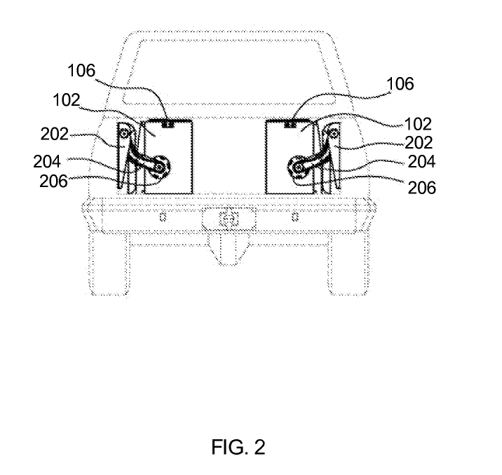

FIG. 2 illustrates a rear view of an exemplary storage assembly in a stowed position in an exemplary vehicle storage portion, in accordance with an embodiment of the present invention. In the present embodiment, the storage assembly may include a pair of arms 202 disposed to join with a container at a pair of mounting ends. The pair of arms may include an arm vehicle end for joining with the vehicle, and an arm container end for joining with the container. In some embodiments, the assembly may remain level in relation to the vehicle storage portion while moving between positions, and while the vehicle is operating. A stabilization portion may provide the assembly the stability to maintain this even keel. In some embodiments, a pair of mounting brackets 204 may join with an inner surface of the vehicle storage sidewalls. Each mounting bracket may join with each arm vehicle end through an anchor sprocket. The anchor sprocket may include a rotary sprocket configuration that is affixed solidly to the mounting bracket. The anchor sprocket may be operable to serve as a rear bearing for pivoting the assembly. The anchor sprocket may not engage or contact the arm, but rather engages the mounting bracket attached to the container mounting end.

In one embodiment, a container pivot assembly 206 may join each mounting end of the container, providing a pivot axle point to operatively join the container to the arm container end. From the arm container end, a pivot sprocket may join with the container by overlaying on the container pivot assembly. The pivot sprocket may include a rotary sprocket configuration that rotates in conjunction with the container assembly, yet also maintains the container at a level position. The pivot sprocket rotates independently of the arm arc movement, by not being on contact with the arm.

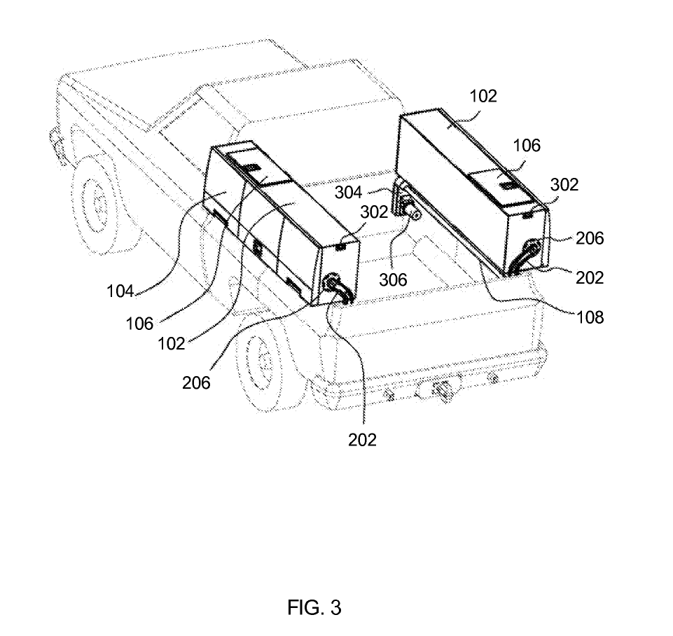

FIG. 3 illustrates a detailed perspective view of an exemplary storage assembly in a raised position in an exemplary vehicle storage portion, in accordance with an embodiment of the present invention. In the present embodiment, a motor 304 powers the assembly. The motor may include, without limitation, an electrical motor, a direct current motor, and an alternative energy motor. The motor may transmit rotational power to the axle through a gear portion 306. A control portion 302 may position on the container, controlling the movement of the assembly. The control portion may include buttons and switches on the container for controlling the power, speed, and direction of movement for the axle. In some embodiments, the control portion may include a remote control that could either be wired or wireless, and may be placed, without limitation, inside the vehicle's cab.

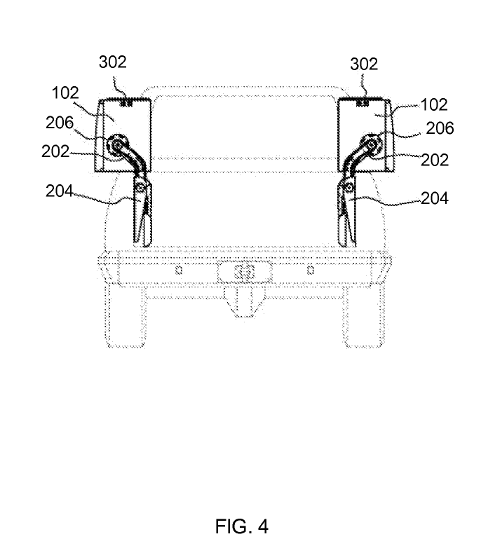

FIG. 4 illustrates a rear view of an exemplary storage assembly in a raised position in an exemplary vehicle storage portion, in accordance with an embodiment of the present invention. In the present embodiment, the at least one arm may then pivotally raise the container through the arc movement to a raised position. In the raise position, the container may rest on the at least one sidewall of the peripheral storage area. For example, without limitation, on the edge of a pickup truck bed.

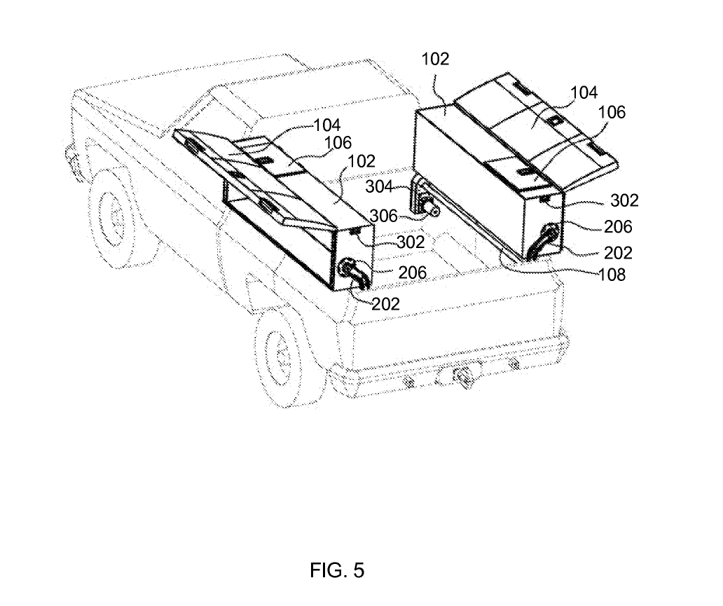

FIG. 5 illustrates a detailed perspective view of an exemplary storage assembly in a raised position in an exemplary vehicle storage portion with an exemplary front door opened, in accordance with an embodiment of the present invention. In the present embodiment, the front door may provide access to at least one item in the container. The front door may not be accessible when the container is in a stowed position due to the sidewall of the vehicle storage portion blocking access.

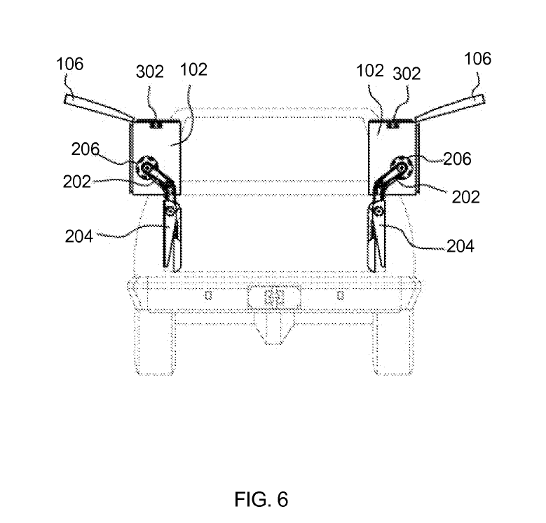

FIG. 6 illustrates a rear view of an exemplary storage assembly in a raised position in an exemplary vehicle storage portion with an exemplary front door opened, in accordance with an embodiment of the present invention. In the present embodiment, the front door may be opened and closed with a hinged pivot. However, in other embodiments, the front door may slide open. Suitable materials for the doors of the container may include, without limitation, steel, titanium, metal alloys, fiberglass, high density polymer, and wood.

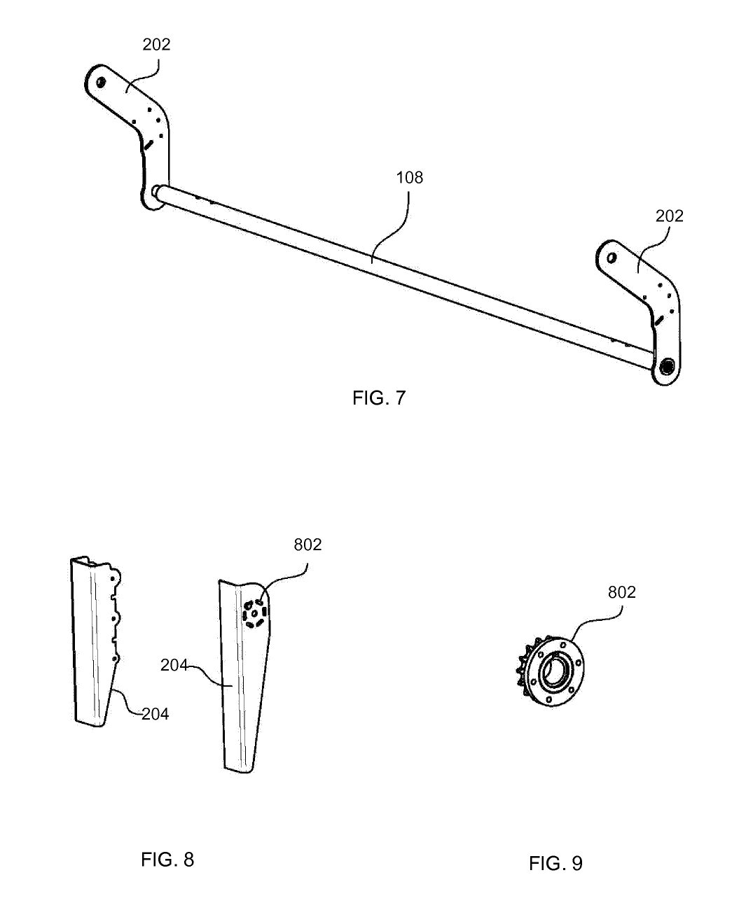

FIG. 7 illustrates a detailed perspective view of an exemplary axle joining an exemplary pair of arms, in accordance with an embodiment of the present invention. In the present embodiment, the axle may extend along a longitudinal axis of a vehicle storage portion, such as the bed of a pickup truck. The motor may power the gearbox assembly, which regulates the torque and speed of the arc movement generated by the axle.

FIG. 8 illustrates a detailed perspective view of an exemplary mounting bracket and an exemplary anchor sprocket attached, in accordance with an embodiment of the present invention. In the present embodiment, a stabilization portion may provide the assembly the stability to maintain this even keel. In some embodiments, a pair of mounting brackets may join with an inner surface of the vehicle storage sidewalls. Each mounting bracket may join with each arm vehicle end through an anchor sprocket 802. The anchor sprocket may include a rotary sprocket configuration. The anchor sprocket may be operable to serve as a rear bearing for pivoting the assembly. The anchor sprocket may not engage or contact the arm.

In one embodiment, a container pivot assembly may join each mounting end of the container, providing a pivot axle point to operatively join the container to the arm container end. From the arm container end, a pivot sprocket may join with the container by overlaying on the container pivot assembly. The pivot sprocket may include a rotary sprocket configuration that rotates in conjunction with the anchor sprocket and the axle, in order to maintain the container at a level position. The pivot sprocket rotates independently of the arm arc movement, by not being on contact with the arm.

FIG. 9 illustrates a detailed perspective view of an exemplary anchor sprocket, in accordance with an embodiment of the present invention. In the present embodiment, the anchor sprocket may operatively join the axle. In this manner, the directional movement of the gearbox portion may control the direction and speed of the container arc movement. The anchor sprocket may include bearings for lubricating the rotational arc movement of the container. The bearings may be, without limitation, ball bearings, roller bearings, or bushings.

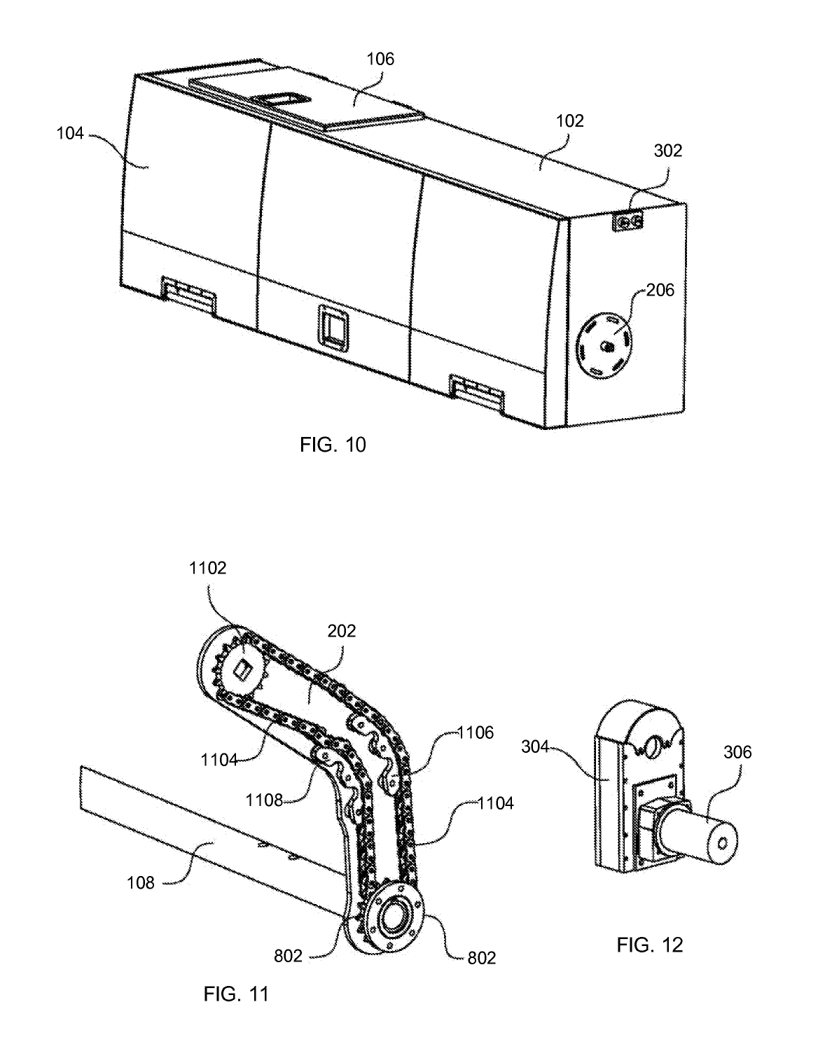

FIG. 10 illustrates a detailed perspective view of an exemplary container with an exemplary container pivot assembly attached, in accordance with an embodiment of the present invention. In the present embodiment, the container may store, segregate, and disperse at least one item. The container may include, without limitation, a tool box, a work bench, and a storage container. Suitable materials for the container may include, without limitation, stainless steel, titanium, metal alloy, high density polymer, fiberglass, and wood. Those skilled in the art, in light of the present teachings, will recognize that two types of users may benefit from the storage assembly. A first type of user may require simply adding basic storage capacity to a stock pickup bed. The solutions offered to these owners are often lower cost, semi-permanent mounted boxes that mount within the cargo space of the pickup truck bed area. The second type of user is the commercial truck buyers and skilled tradesman that require such an extensive storage and organization of tools that they actually replace the original pickup truck bed with a new bed made entirely of tool boxes. The present invention may be configured to address needs for both types of users.

FIG. 11 illustrates a detailed perspective view of an exemplary arm with a stabilization portion attached, in accordance with an embodiment of the present invention. In the present embodiment, the container pivot assembly may join each mounting end of the container, providing a pivot axle point to operatively join the container to the arm container end. From the arm container end, a pivot sprocket 1102 may join with the container by overlaying on the container pivot assembly. The container pivot assembly is attached to the container. The container pivot assembly contains a pivot shaft at its center. This pivot shaft is round nearest the container, which acts as a bearing surface, and is squared off at the end away from the container. When the container is mounted to the arm with the stabilization portion, the pivot shaft extends through the arm and the square portion receives the pivot sprocket. The arm contains a bearing assembly. When the assembly is completed, the container rotates in the arm and the pivot sprocket is solidly attached to the toolbox by its attachment to the square end of the pivot shaft. The pivot sprocket may include a rotary sprocket configuration that rotates in conjunction with the anchor sprocket and the axle, yet also maintains the container at a level position. The pivot sprocket rotates independently of the arm arc movement, by not being on contact with the arm.

In one embodiment of the present invention, a chain portion 1104 may form a loop around the pivot sprocket and the anchor sprocket. The chain portion may follow a path around an outer perimeter of each arm by rolling around a chain guide 1106. The chain portion may also engage a tensioning guide 1108 configured to increase and decrease tension on the chain portion through slight adjustments in positioning. In operation, the chain portion forms a bridge between the anchor sprocket and the pivot sprocket. As the axle drives the lifting arm, the chain portion drives the pivot sprocket, which maintains a relative position with the anchor sprocket. Since the pivot sprocket overlays and moves in conjunction with the container pivot assembly, the container maintains the same relative orientation to the vehicle storage portion at any point along the arc movement.

FIG. 12 illustrates a detailed perspective view of an exemplary container with an exemplary motor and an exemplary gearbox portion, in accordance with an embodiment of the present invention. In the present embodiment, the motor may be regulated by the control portion on the container, or remotely. The motor may control the speed, direction, and torque of the assembly. In some embodiments, the tool box may be heavy requiring more than one motor. In some embodiments, the motor may be, without limitation, an electric motor, hydraulic motor, pneumatic motor, hydraulic linear actuator via a lever arm, or electric linear actuator via a lever arm.

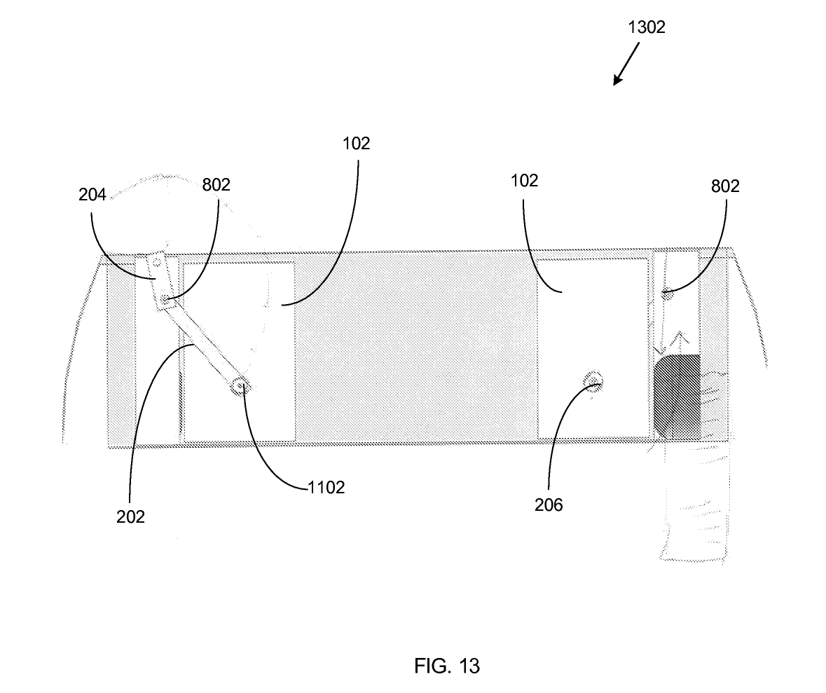

FIG. 13 illustrates a rear view of an exemplary container in a stowed position in a vehicle storage portion, in accordance with an embodiment of the present invention. In the present embodiment, the container may raise and lower though the arc movement between two positions, on a perimeter area of the vehicle storage portion, and on at least one sidewall of the vehicle storage portion. The container may rest in the perimeter area when in a stowed position 1302. The stowed position may be configured to minimize space consumption in the vehicle storage portion. For example, without limitation, the container may stow inside a wheel well of a pickup truck.

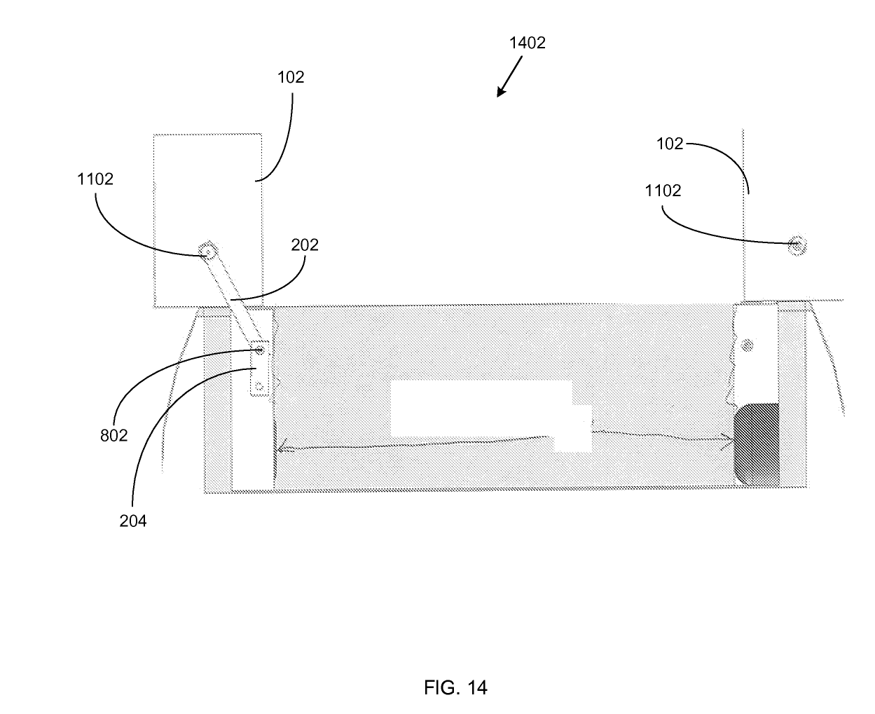

FIG. 14 illustrates a rear view of an exemplary container in a raised position on a top edge of at least one sidewall, in accordance with an embodiment of the present invention. In the present embodiment, the at least one arm may then pivotally raise the container through the arc movement to a raised position 1402. In the raise position, the container may rest on the at least one sidewall of the peripheral storage area. For example, without limitation, on the edge of a pickup truck bed. A stabilization portion maintains the container in a level, stable orientation during movement between each position, and while the vehicle is operating. In some embodiments, the container locks onto the at least one sidewall through friction and/or mechanical connections of the at least one arm. The lock mechanism may be actuated when the at least one arm presses the container down on a top edge of the at least one sidewall, thereby removing any slack in the connection between the container and each arm. Frictional forces and gravity may then enhance the locked, raised position of the container. The locking mechanism may allow the vehicle to be driven while the container is in the raise position.

In one alternative embodiment, the pair of arms may be utilized to lift objects other than toolboxes, such as bales of hay, feed, concrete, etc. In yet another alternative embodiment, the chain portion contains its own motor, rather than relying on the axle. In yet another alternative embodiment, the container utilizes weights on a base surface to enhance the stability. In yet another alternative embodiment, the pair of arms may include a hinge in the middle for increasing the turn capacity of the arc movement. In yet another embodiment, a multi-point linkage assembly may be used in place of the chain assembly to keep the box stable through the motion.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a lifting and lowering assembly for containers in a vehicle storage area according to the present invention will be apparent to those skilled in the art. Various aspects of the invention have been described above by way of illustration, and the specific embodiments disclosed are not intended to limit the invention to the particular forms disclosed. The particular implementation of the lifting and lowering assembly for containers in a vehicle storage area may vary depending upon the particular context or application. By way of example, and not limitation, the lifting and lowering assembly for containers in a vehicle storage area described in the foregoing were principally directed to arms that lift tool boxes in a level, arc movement from a truck bed stowage area to the edge of a truck bed implementations; however, similar techniques may instead be applied to loading and unloading containers from a container ship, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus comprising:
at least one mounting bracket engaged with an inside of a vehicle cargo area;
an axle having a first end portion and a second end portion, the axle oriented longitudinally inside the vehicle cargo area to engage with the at least one mounting bracket;
a first radius arm having a container end portion and a vehicle end portion, the vehicle end portion being engaged with the first end portion of the axle and the container end portion being engaged with a first pivot assembly on a container; and
a second radius arm having a container end portion and a vehicle end portion, the vehicle end portion being engaged with the second end portion of the axle and the container end portion being engaged with a second pivot assembly on the container,
wherein the first and second radius arms are configured to be operable to deploy the container from the inside of the vehicle cargo area to a sidewall of the vehicle cargo area in a generally arcing motion.

2. The apparatus of claim 1, further comprising a stabilization portion located along the first and second radius arms for maintaining the container in a stable orientation during movement.

3. The apparatus of claim 2, wherein the stabilization portion comprises:
an anchor sprocket engaged with one of the at least one mounting bracket;
a container pivot assembly engaged with the container, wherein the container pivot assembly comprises a pivot shaft at its center, wherein the pivot shaft comprises a round portion and a square portion;
a bearing assembly engaged with the container end portion of the first or second radius arm and operatively connected to the round portion of the pivot shaft;
a pivot sprocket operatively engaged with the square portion of the pivot shaft; and
a chain portion looping around the anchor sprocket and the pivot sprocket.

4. The apparatus of claim 3, further comprising a chain guide for allowing the chain portion to follow a path around an outer perimeter of the first or second radius arm.

5. The apparatus of claim 3, further comprising a tensioning guide for allowing adjustment in tension of the chain portion.

6. The apparatus of claim 2, wherein the stabilization portion is a multi-point linkage assembly.

7. The apparatus of claim 1, further comprising a motor with a gearbox portion operatively engaged with the axle for transmitting rotational power to the axle.

8. The apparatus of claim 7, wherein the motor is an electric motor.

9. The apparatus of claim 7, further comprising a control portion for controlling the motor.

10. The apparatus of claim 9, wherein the control portion is located on the container.

11. The apparatus of claim 9, wherein the control portion is located inside the cab of the vehicle.

12. The apparatus of claim 2, further comprising a motor to provide rotational power to the stabilization portion.

13. The apparatus of claim 1, further comprising the container engaged with the container end portions of the first and second radius arms.

14. The apparatus of claim 13, wherein the container comprises a weight on a base surface to enhance stability.

15. The apparatus of claim 1, wherein the vehicle is a truck.

16. The apparatus of claim 1, wherein the vehicle is a ship.

17. An apparatus comprising:
at least one mounting bracket engaged with an inside of a vehicle cargo area;
an axle having a first end portion and a second end portion, the axle oriented longitudinally inside the vehicle cargo area to engage with the at least one mounting bracket;
a first radius arm having a container end portion and a vehicle end portion, the vehicle end portion being engaged with the first end portion of the axle and the container end portion being engaged with a first pivot assembly on a container;
a second radius arm having a container end portion and a vehicle end portion, the vehicle end portion being engaged with the second end portion of the axle and the container end portion being engaged with a second pivot assembly on the container,
wherein the first and second radius arms are configured to be operable to deploy the container from the inside of the vehicle cargo area to a sidewall of the vehicle cargo area in a generally arcing motion; and
a stabilization portion located along the first and second radius arms for maintaining the container in a stable orientation during movement,
wherein the stabilization portion comprises:
an anchor sprocket engaged with one of the at least one mounting bracket;
a container pivot assembly engaged with the container, wherein the container pivot assembly comprises a pivot shaft at its center, wherein the pivot shaft comprises a round portion and a square portion;
a bearing assembly engaged with the container end portion of the first or second radius arm and operatively connected to the round portion of the pivot shaft;
a pivot sprocket operatively engaged with the square portion of the pivot shaft;
a chain portion looping around the anchor sprocket and the pivot sprocket;
a chain guide for allowing the chain portion to follow a path around an outer perimeter of the first or second radius arm; and
a tensioning guide for allowing adjustment in tension of the chain portion.

18. An apparatus comprising:
a mounting means for mounting a rotating means inside of a vehicle cargo area;
a rotating means for rotating a first and second radius arm engaged with a container inside the vehicle cargo area; and
a radius arm means for deploying the container from inside of the vehicle cargo area to a sidewall of the vehicle cargo area in a generally arcing motion.

19. The apparatus of claim 18, further comprising a stabilization means for maintaining the container in a stable orientation during movement.

20. The apparatus of claim 18, further comprising a control means for controlling the rotating means.
